(19) United States
(12) Patent Application Publication
(10) Pub. No.: US 2004/0205519 A1
(43) Pub. Date: Oct. 14, 2004

(54) Method and system for automatically generating construction documents

(76) Inventors: Chris Chapel, (US); John McLinden, Libertyville, IL (US); Gord Gavrilovic, Kitchener (CA); Sean Jancski, Fairfield, CT (US)

Correspondence Address: David M. Dingeman, 550 Trees Drive, Cedar Hill, TX, 75104, US

(21) Appl. No.: 10/044,262

(22) Filed: Jan. 10, 2002

(51) Int. Cl. G06F 17/00

(52) U.S. Cl. 715/502; 715/526

(57) ABSTRACT

The present invention provides for a method and system of automatically generating time-scaled work plans using customized user interfaces to access back-end estimating software; export quantities from third party computer-aided design software into an external database; import quantities into estimating software to calculate costs, and assign activity relationships between relational database information to automatically produce third party project schedules. The present invention accesses back-end data from third party computer-aided design software, estimating software and project schedule software to produce planning documents, execution documents and time-scaled work plans by means of a graphical user interface and object-oriented database.

### BACKGROUND OF THE INVENTION

The present invention relates to a computer system, graphical user interface, method and system for automatically generating and updating construction planning and project schedules, project status, material lists and other construction execution documents.

The present invention provides a construction planning system that links existing third party software applications to the present solution to produce the planning and execution documents required for construction projects. Construction projects are very complex and include many phases such as planning, preliminary engineering, final design, construction, quality assurance, completion, revenue and billing.

Construction planners, project managers, contractors, subcontractors and customers (“users”) need a tool which streamlines these phases into a manageable system by providing project management oversight, project efficiency improvements, risk management assessment, material oversight and financial assessments. The present invention helps to solve these problems by providing a system and method to adding intelligence to drawings which eliminates the need for manual quantity takeoff. As used herein, the term “quantity takeoff” is defined as the method of extracting the quantitative fields and numerical values from a construction computer-aided design to utilize this design data in other reports and execution documents. The present invention automatically captures the quantity takeoff values of the design and captures sequence information to generate project schedules; bill of materials (“BOM”); assembly quantities and descriptions; element quantities and descriptions; and a detailed work plan. As used herein, the term “work plan” is defined as a detailed, construction project plan, construction documents and optimized schedule that identifies materials required, project activities, project sequence, team size, production rate and resources for a specific time frame. Construction documents, as used herein, are defined as those documents which are reviewed, approved and stamped by a licensed engineer for use as documents to build from and that which create contractual liability on the part of the builder.

### DESCRIPTION OF THE PRIOR ART

The prior art solutions to project planning and report generation have been limited to providing manual solutions to only part of a complex problem. The present invention provides a novel solution that allows the user, such as a project manager, to automatically extract information from third party, computer-aided design applications, estimating software and project planning software to create complex project schedules, BOMs, work plans and construction documents.

Although there are no known prior art teachings of a solution to the aforementioned deficiency and shortcoming such as that disclosed herein, the following prior art discusses subject matter that bears some relation to matters discussed herein.

John M. McCormick, U.S. Pat. No. 5,893,082—System for Processing and Presenting Cost Estimates in the Construction Industry, Apr. 6, 1999 includes estimating hardware for interacting with a plan print to count and/or scale off measurements of assemblies and/or items on the plan print and input such counts and/or measurements into the CPU for processing. In addition, McCormick discloses a memory unit storing the scanned data into a record list database for use in user interface takeoff windows for estimating construction costs. McCormick only provides for quantity takeoff performed by digitizer that scans in the actual data from hard-copy blueprints. McCormick does not contemplate extracting information from computer-aided designs for use in the automatic generation of construction reports and execution documents.

Linda Marie Hartman, U.S. Pat. No. 6,236,409—Method and Apparatus for Computer Aided Building Specification Generation, May 22, 2001, provides for producing a design document for a product with the product having product elements arranged in hierarchical manner and stored in a relational database. Hartman provides for relating product elements to text elements to produce a design document.

Gary M. Krause, U.S. Pat. No. 5,526,520—Method to Organize and Manipulate Blueprint Documents Using Hypermedia Links from a Primary Document to Recall Related Secondary Documents, Jun. 11, 1996, discloses a method to organize documents hierarchically whereby a primary document contains links to secondary documents which allows the user to quickly navigate to relevant project information.

Kenji Ito, U.S. Pat. No. 5,761,674—Integrated Construction Project Information Management System, Jun. 2, 1998, provides for a unitary management of information for construction projects by collecting data in one repository and allowing various users to access views of that data that is relevant to them.

W. Curtis Broughton and Randal S. Hosler, U.S. Pat. No. 5,920,849—System and Method for Evaluating Building Materials, Jul. 6, 1999 discloses a system and method to assist contractors in producing competitive bid proposals. Specifically, Broughton et al provide a solution whereby the user will enter at least one characteristic of the first and second items, a processor selects a fitting which connects the items and the cost of the first item, second item and fitting are displayed to the user.

Leo Rosenthal, Leonard M. Isaacson and John A. Ziebarth, U.S. Pat. No. 4,181,954—Computer-aided Graphics System Including a Computerized Material Control System and Method of Using Same, Jan. 1, 1980, discloses a system and method for automatic calculation of three-dimensional points of selected valves and fittings on a pipeline. The user may view this calculated data by selecting a function to plot the generated data or create material lists and status reports.

### SUMMARY OF THE INVENTION

The present invention is a method and system that integrates third party design and project software with customized graphical user interfaces, software interfaces, data attributes and databases that result in construction documents, BOMs and work plans.

The prior art does not provide an adequate, automated solution to creating construction documents, BOMs and work plans. The prior art solution often resulted in construction projects that are risk-prone and cost overruns which were paid for by the customer. What is needed is a method and system that resides on a user's personal computer utilizing present Microsoft Windows environment and ODBC drivers to access, define, export and import data from third party software such as computer-aided design software, project scheduling software and estimating software, such as AutoCAD 2000i, Microsoft Project, and Timberline Estimating applications, respectively. What is needed is a tool which provides a customized user interface to a computer-aided design software such as AutoCAD 2000i to intelligently link data associated with the construction design and a second interface that accesses project and estimating information from estimating software such as Timberline Precision Estimating software.

A further need exists for an application to export relevant construction design data from AutoCAD into an external database to automate the process for creating construction costs and material lists. A need also exists for an interface to import construction material lists and quantities from the external database into an estimating software such as Timberline Precision Estimating system that enables the system to assign costs and recalculate costs based on newly imported construction design, material and cost data. A further need exists for a database to store the construction design data, material lists, quantities, and costs. A need also exists for an interface to assign activity relationships to this data stored in the database creating an automated project schedule utilizing third party project scheduling such as Microsoft Project. A need exists to extract data from third party design software, estimating software and project software to automatically create a detailed time sequenced construction work plan.

In summary, a need exists to add intelligence to construction drawings eliminating the need for manual quantity takeoff as provided by the prior art. Construction project sequence information is extracted by means of a customized interface to capture, export and store this data into a knowledge-based database providing for reduced time needed to create project schedules manually. This captured and manipulated data is also used to automatically create building material lists with quantities and descriptions thereby eliminating the need to create these lists manually and improving the time required to create such lists. In the preferred embodiment of the present invention a detailed work plan, created automatically, is the final result of the present invention that includes detailed construction drawing information, material lists, quantities, descriptions, crew and resources for user identified time periods eliminating the need to manually coordinate construction documents. The automatic creation of construction work plans, material lists and execution documents to be accessed by multiple users provides for overall efficiency improvements in the time required to create such documents. In addition, this results in improved communication between those responsible for construction projects because all users are accessing information from one database by means of one tool.

### BRIEF DESCRIPTION OF THE DRAWINGS

The present invention relates to a computer system, graphical user interface and method for automatically generating and updating construction execution documents, project schedules, project status, BOMs, and work plans. This invention will be better understood and its numerous objects and advantages will become more apparent to those skilled in the art by reference to the following drawings, in conjunction with the accompanying specification, in which:

FIG. 1 (Prior Art) is a hardware/software schematic illustrating the general method of operation of the prior art.

FIG. 2 (Prior Art) is a schematic diagram illustrating the computer hardware system of the prior art.

FIG. 3 is a user system architecture of the present invention.

FIG. 4 is system schematic for a single user of the present invention in the preferred embodiment.

FIG. 5 is a flow chart of the construction planning system (“CPS”) project interface of the present invention.

FIG. 6 is a screen-capture of an example of the electronic drawing conversion application interface of the present invention in the preferred embodiment.

FIG. 7 is a screen-capture of an example of the link editor application interface of the present invention in the preferred embodiment.

FIG. 8 is a screen-capture of a resulting work plan output of the present invention in the preferred embodiment.

### DETAILED DESCRIPTION OF THE DRAWINGS

The present invention provides for a construction planning method and system that links third party applications to produce construction work plans, BOMs and execution documents. In a preferred embodiment, the present invention is a software application tool, user interface, and a database that are accessed by a user through their personal computer along with third party software used in construction design, cost estimating and project scheduling. In a preferred embodiment, this third party software includes but is not limited to: AutoCAD 2000l, Architectural Desktop interface; Timberline Precision Estimating software; Microsoft ODBC driver; Microsoft Access 2000; web browser such as Microsoft Internet Explorer 5.x or Netscape; Microsoft Project or Primavera. The present invention provides a customized visual basic interface and construction planning system interface to create the resulting construction work plans, and execution documents.

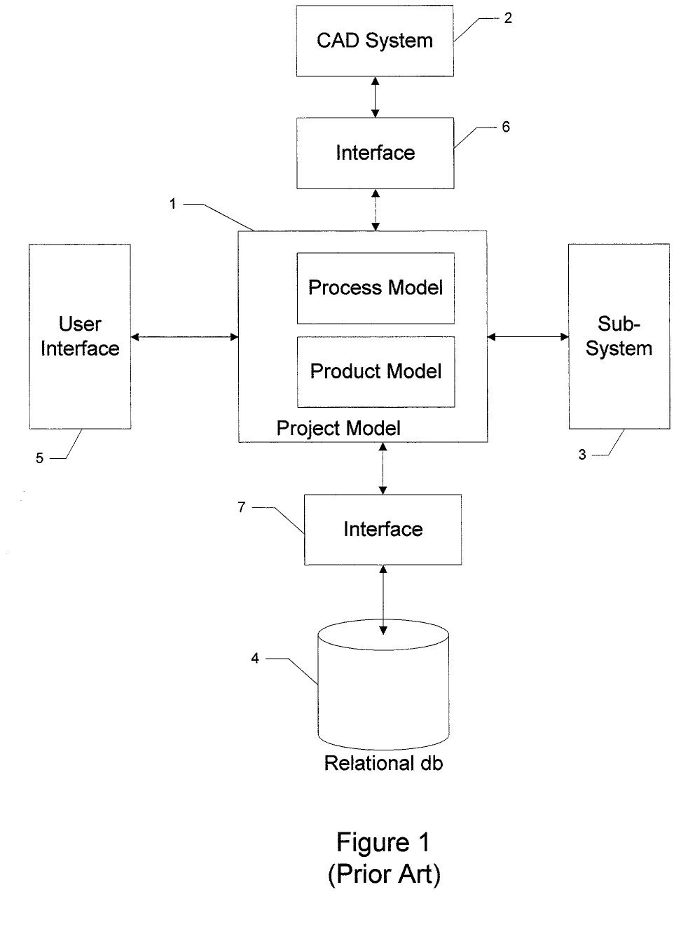

FIG. 1 is a hardware/software schematic illustrating the general method of operation of the prior art. Prior to the solution disclosed by the present invention; the problem of utilizing data from construction drawings was limited by a very tedious, manual mode of operation.

FIG. 1, shows one prior art method of attempting to solve the problem of creating construction planning documents whereby a method and system of an integrated construction project information management system is shown. A computer-aided design (“CAD”) system 2 is used to create electronic drawings of construction designs and plans by means of various interfaces 6 such as tools to define columns, girders, walls, rooms; and a file interface used to prepare a file to provide design information to a building model. Information from the CAD system 3 and the interfaces 6 creates a Project Model, Process Model and Product Model, collectively referred to at 1. The Product Model is prepared by defining a building with physical elements such as columns, girders; and functional elements such as walls and rooms. The Process Model is generated by analyzing each of the productive activities and defining them as a productive activity model. The Project Model is created as a collection of information from the process and product models resulting in a cumulative and interrelated design-construction planning environment. The project model information is exported to sub-system 3 which is a collection of expert systems and other applications, for example, an expert system that evaluates and calculates a roughly estimated construction period in accordance with the process or flow of the building production by using information collected from the process model, product model and by inquiries made to the user by means of the user interface 5. A relational database 4 stores information about the finishing cost for each building element or member, information on clients, and other personnel information. Interface 7 gathers required information from relational database 4 for use in further developing Project Model 1. Various views of the collected information are presented to the user by means of user interface 5 showing management, cost, planning and sales estimates.

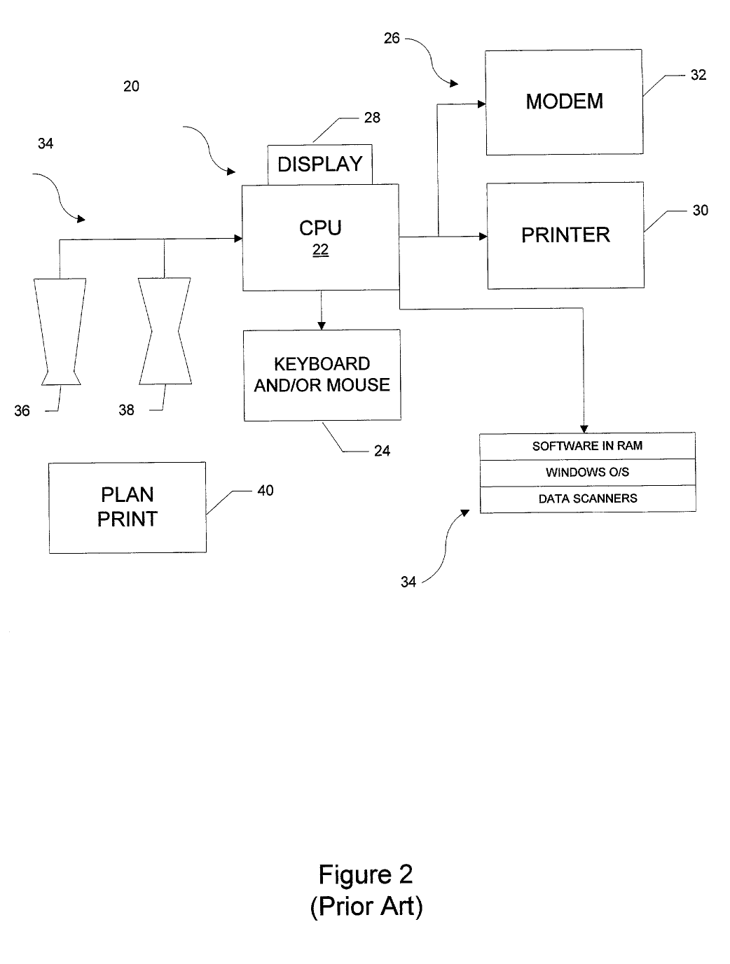

FIG. 2 is a schematic diagram illustrating the computer hardware system of the prior art. In FIG. 2, computer system 20 is comprised of a display 28, central processing unit (“CPU”) 22, keyboard and/or mouse 24, and output hardware 26. Output hardware may be comprised of modem 32 and printer 30. CPU 22 is directly connected to estimating hardware 34 which may be a counting pen 36, scaling probe 38 or other estimating tools for interacting with a plan print 40 to count items, assemblies, or to scale off measurements such as lengths of assemblies and entering such counts into CPU 22. Through the use of computer system 20, a user or estimator may make cost estimates from a plan print relating to various construction projects costs such as electrical costs, plumbing costs, heating costs, labor costs and overall costs. Counting pen 36 and scaling probe 38 are common digitizing, counting and scanning tools that are required to gather data from a standard construction blue print.

Computer system 20 also includes a memory unit 42, at least one assembly database 44 and at least one item database 46. Assembly database 44 includes an assembly information record list and the item database 46 includes an item information record list relation to the assembly information record list. For example, assembly database 44 contains a numerical listing of the potential assemblies used in a construction project such as electrical, plumbing, heating and air conditioning; the cost of each of these assemblies and the cost of installing these assemblies which is input by an operator or user. Item database 46 contains breakdown costs of each individual component which make up the assemblies. With databases 44 and 46 along with scanners and digitizers 36 and 38, a user may generate an assembly or item cost list by using the digitizer to scan lengths of items from the blue print based on item number and have the CPU 22 calculate costs based on standard values in the databases.

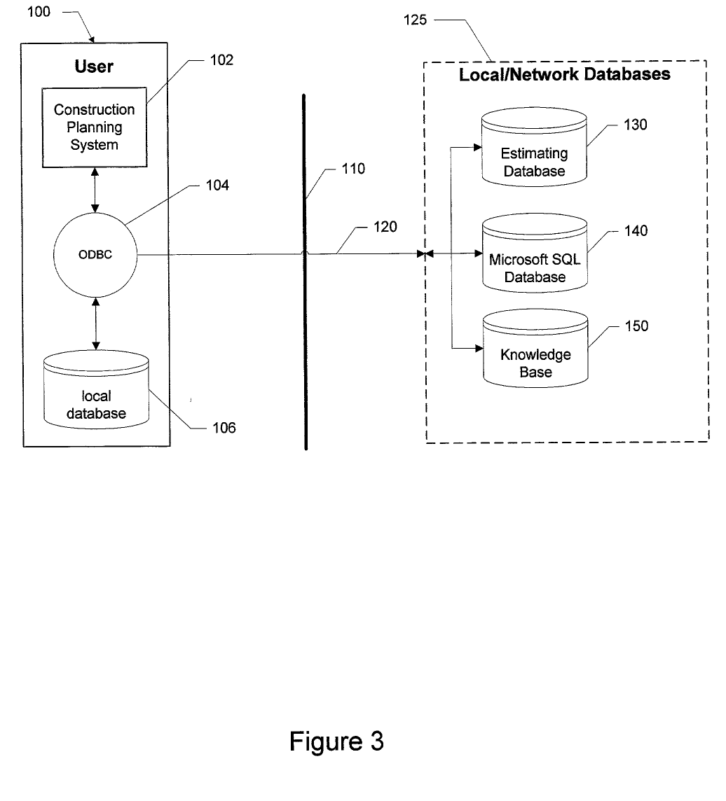

FIG. 3 is a system architecture of the present invention. In FIG. 3, the user utilizes a local computing environment 100 such as an IBM compatible personal computer with elements of the present invention including application 102, open database connectivity (“ODBC”) 104, and local databases 106. Computing device 100 may be a personal computer with Microsoft Windows operating system utilizing a Microsoft Windows user environment or a web browser such Microsoft Internet Explorer 5.x. ODBC 104 is an open standard application programming interface for accessing a local or networked database. ODBC is advantageous because it allows programs to use structured query language requests that will access databases without having knowledge of the proprietary interfaces to the databases. The user can access files in a number of different databases by using ODBC statements in a program. Such databases may be local database 106 or additional databases 125 such as estimating database 130, Microsoft Structured Query Language (“SQL”) database 140, and the construction planning system knowledge base database 150. The estimating database 130 is a third party database such as Timberline Estimating software database. The Microsoft SQL database 140 or similar is the database which stores the project planning software data. Microsoft SQL is used because it is a standard, interactive programming language for retrieving and updating data in a database. The knowledge base database (“KBDB”) 150 is automatically created for and used by the present invention to store the data required necessary to create the construction execution documents and detailed work plans.

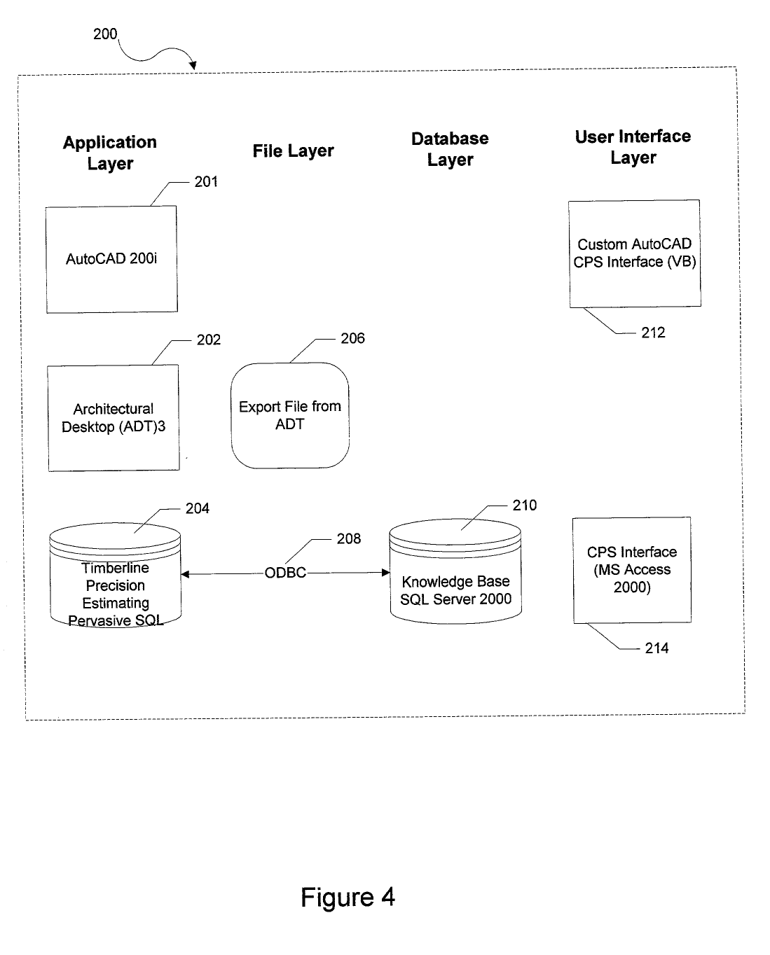

FIG. 4 is system schematic for a user of the present invention in the preferred embodiment. In FIG. 4, the user operates computing device (FIG. 3 at 100). In a preferred embodiment, the user's operating environment is comprised of software application tool, user interface, and a database that reside on a user's personal computer along with third party software used in construction computer-aided design and project scheduling. In a preferred embodiment, the user's computer environment 200 is comprised of but not limited to: AutoCAD 2000i 201, Architectural Desktop 202, Timberline Precision Estimating software 204, Microsoft ODBC driver and Timberline ODBC drivers 208, knowledge base database 210, construction planning system computer aided design interface 212, construction planning system (“CPS”) interface, SQL Server 2000, Microsoft Access 2000 214, a web browser such as Microsoft Internet Explorer 5.x, and Microsoft Project. The present invention provides a CPS computer aided design interface 212 and CPS interface 214 to create the resulting construction planning and execution documents.

The user launches a third party CAD software application such as AutoCAD 2000i 201 to view a specific construction design, such as the three-dimensional design of a building, manufacturing plant, utility plant or office building. This electronic CAD drawing contains detailed material drawing information such as building dimensions and materials which includes specific dimensional data for each element and assembly of the building. At 202, the user launches a third party CAD desktop user interface such as Architectural Desktop to view detailed element information included in the CAD electronic drawing. At 212, the user opens the customized, CAD computer user interface which is written in Visual Basic to access the construction data stored in the back-end of the CAD tool 201. The user executes an algorithm at 212 to export construction data from CAD tool 201 and CAD user interface 202 to create an ascii export file 206 which contains detailed dimensional and material information captured from the CAD tool 201.

The user launches a project estimating tool such as Timberline Precision Estimating application and database 204 and opens CPS project interface 214 to import ascii export file 206. Using CPS project interface 214, the system assigns costs to the detailed material list information. Third party estimating software 204 is used to recalculate costs based on the detailed material list and relevant elemental, cost information input by the user. The user, by means of the CPS project interface 214, assigns activity relationships between the assemblies and items, to produce a knowledge base database at 210. This data, stored at 210, along with project estimates, crew required, and other resources required, can then be accessed by Microsoft Project to produce detailed project schedules or using the CPS project interface to produce a time scaled work plan.

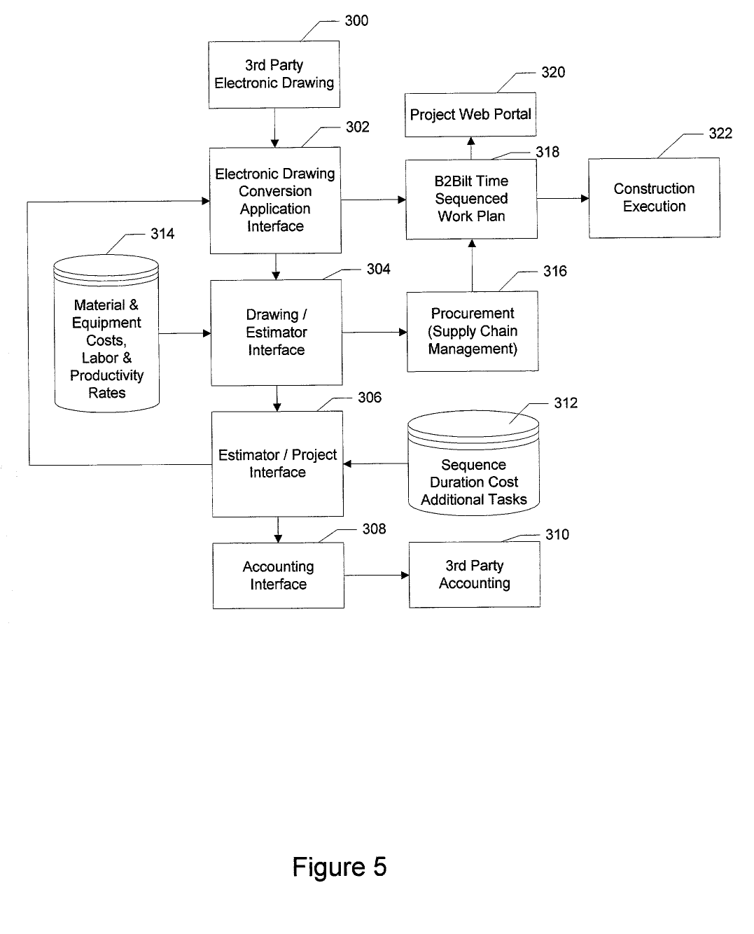

FIG. 5 is a flow chart of a typical user session of the CPS system and method of the present invention showing the minimum steps to create a work plan and construction execution documents based on logically describing objects from third party computer-aided design software, estimating software, project planning software. The user uses the CPS interfaces to link objects from the third party applications to material and cost inputs resulting in a complete knowledge base database from which the work plan and construction execution documents are created. Examples of output data resulting from the construction planning system application include project phase label, project face description, quantity, labor cost per unit, labor price, labor amount, material price and material amount for each assembly and element.

In the preferred embodiment, the user has already created a construction design of a building or power plant for example, through third party computer-aided design software. At 300, the user has created an electronic drawing by using AutoCAD 2000 and defined basic attributes of the design such as building type, approximate square footage and location. The user designing the building in the third party design software also adds information on the elements and assemblies of the design. An assembly is comprised of a group of related elements, for example; a wall may be an assembly made up of the elements of drywall, fasteners, and a frame. At 302, the user utilizes the system and user interfaces of the present invention to convert the third party electronic design software information to a knowledge based drawing for use in the present invention. Utilizing the CPS application interface, the user would export the assembly and element information that make up the design. For example, the location and dimensions of each assembly and element are exported to a standard ascii, text file. At 302, the user utilizes the electronic drawing conversion application interface to automatically convert the electronic design drawing to an ascii file that contains drawing information; this information is stored in the knowledge base database and modified in the system to create an intelligent table of assemblies, elements, materials and dimensions. Using the present invention, the user adds further detail to the assembly and element data by linking assemblies to elements and defining detailed material type, size, thickness, and quantities. In a preferred embodiment, the user executes the electronic drawing conversion interface to assign “intelligence” to the objects within the drawing by choosing the corresponding item from the drawing database and linking that information to the object. Once the “intelligence” has been assigned to the objects in the electronic drawing, the user can export the quantities related to these items into an ascii text file. By means of a link editor application interface the user may edit, delete or modify the intelligence and links added to the assembly and element objects.

At 304, the drawing estimator interface is used to calculate design and project costs based on elements and assemblies exported from the design software. This interface accesses the ascii text file and provides a user interface to display the elements and assemblies. The user adds additional cost information to assemblies and elements to create a new cost table. Besides user input, costs may also be derived or looked up by the user from a material, equipment costs and labor productivity rates database 314. A sequence project duration cost database 312 is also accessed to provide more realistic cost information based on industry information. After detailed costs and quantities are assigned to each element and assembly; this additional information becomes the new basis to recalculate more accurate project cost information in the third party estimating software.

At 306, an estimator project interface is used to assign activity relationships from the knowledge base database to produce a project schedule such as a Microsoft Project schedule. This estimator project interface uses standard, automated SQL statements by means of ODBC to access the Microsoft Project database objects. In a preferred embodiment, a project schedule is created using activity relationship information stored within the knowledge base database. Information is added to the knowledge base database through the drawing estimator interface by assigning predecessors and successors to the estimating software assemblies. Project sequence information is assigned from the knowledge base database and project duration are derived from information stored in the estimating software.

After converting the drawing, utilizing the drawing estimator interface and the estimator project interface; the system returns to the construction planning application interface at 302 and automatically creates the work plan. At 322, the construction planning system automatically creates the construction execution documents. In addition, a user may review the results by means of the world wide web utilizing a standard web browser. In a preferred embodiment, the electronic design software is AutoCAD, the estimating software is Timberline and the project schedule software is Microsoft Project. By selecting a specific time frame, the user can generate the work plan based on information added, linked and derived from the knowledge base database.

The user can select the time frame to view a drawing representing only the work to be performed during that time. The drawing also includes information regarding materials, resources, schedule, and production status. Construction execution documents are created which show the electronic drawing with coloring automatically added to the drawing to show the status of the project. In the preferred embodiment, the construction planning application adds the color green to those assemblies and elements to indicate work ahead of schedule, yellow to indicate currently scheduled work, and red to indicate work behind schedule.

At 308, a user may also utilize the accounting interface to generate bill of material lists with detailed cost and quantity information to export to a third party accounting software application 310.

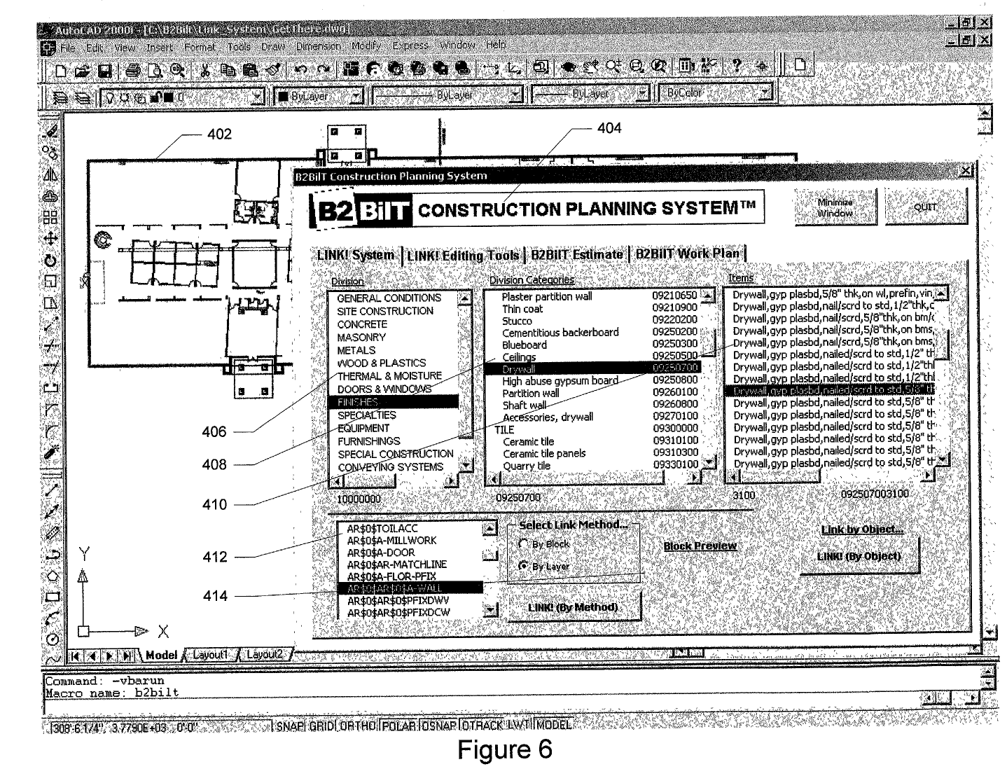

FIG. 6 is a screen-capture of an example of the electronic drawing conversion application interface of the present invention in the preferred embodiment. In this example, the application is used to intelligently link individual assemblies and elements from the third party electronic drawing application to become intelligent objects for use by the present invention to automatically create construction project work plans and construction execution documents. This example is just one implementation of the present invention and is presented in order to distinctly point out the principles discussed herein and should not be construed to limit the scope of the present invention. The user opens third party electronic drawing application 402, specifically, in this example, an AutoCAD drawing of a building. The drawing may be at any design stage; however 402 shows that the building design is near a final stage where walls, windows, hallways and other details are drawn. The user opens interface application of the present invention which opens a user interface identified at 404. This particular tab of the present application enables the intelligent linking of objects in the third party electronic drawing application to objects that have definition in the present application. The present invention at 404 is comprised of standard construction divisions 406, construction division categories 408, detailed construction items 410, third party electronic design object identification 412, and object linking methods 414. At 402, the user selects an assembly or element by using standard point and click techniques or scrolls through the third party electronic design object identification list 412 and selects the object to link. The user then utilizes the present invention and identifies the specific details of the assembly or element selected. In the present example, the user has selected a “wall” object from the AutoCAD drawing 402 and intelligently defined this object as a “finish” at 406, made of “drywall” at 408 and that the drywall is of type “drywall, gyp, plasbd, nailed/scrd to std, 5/8” at 410. The user actually intelligently links the object from 412 to the characteristics of 406, 408 and 410 by selecting a linking method at 414. Methods include but are not limited to linking by layer, block or by object. “Intelligent objects” are the result of assembly and element objects with added, linked descriptions based on construction categories as disclosed. These intelligent objects, by means of the application interface may be output to an ascii text file listing assemblies and elements from the third party electronic design to detailed information that has meaning and relevance to the final output of the work plan and construction execution documents including quantities.

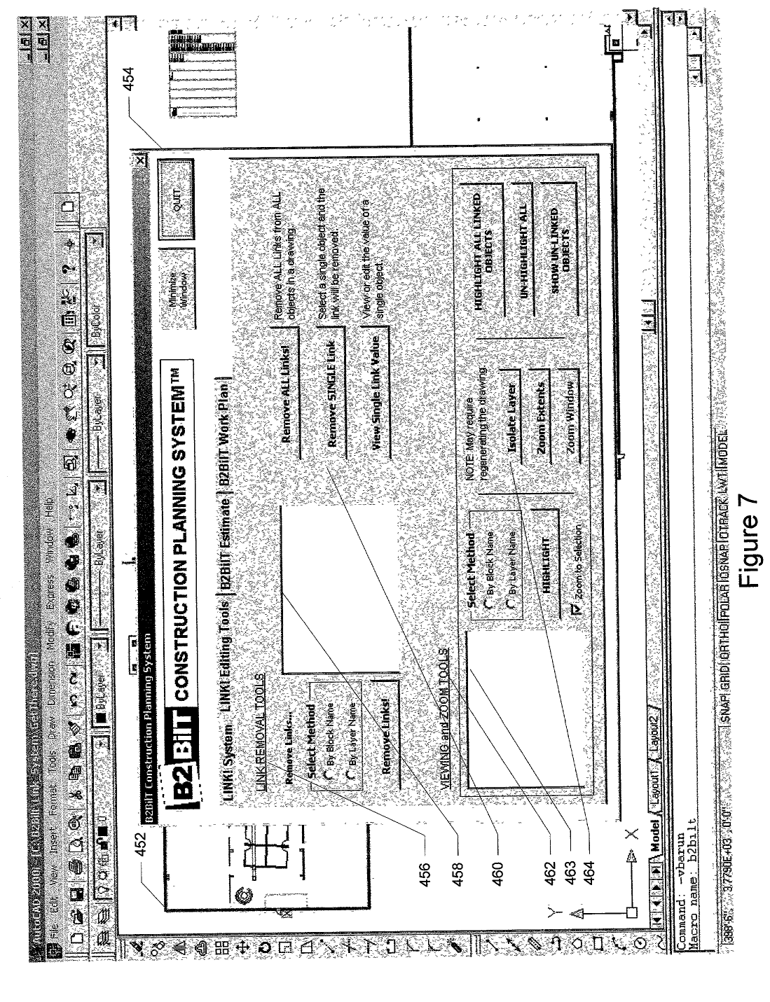

FIG. 7 is a screen-capture of an example of the link editor application interface of the present invention in the preferred embodiment. As with the electronic design application interface, the user opens the third party electronic design software. At 452, the user has opened an AutoCAD drawing with a building along with design elements shown. The user launches the link editor application 454 comprised of link removal tools 456, object display box 458, link removal tools 460, viewing and zoom tools 462, and layer/objects tools 464. It is assumed that the user has previously defined at least one intelligent object using the electronic drawing application interface. All intelligent objects created are displayed in the object display box 458. The user may utilize the link removal tools to select, modify or delete the intelligent links previously created by either block name or layer name as the user had previously defined the link. Additional link editor tools at 460 include removing all links previously created and displayed in the object display box 458, remove a single link, view the properties of a single link value or modify the properties of a single link. In addition, the user may utilize the view and zoom tools 462 by with objects displayed in the second object display box 463 and view selected objects in the electronic design application which may be highlighted, viewed and zoomed in or out. Additional layer/object tools 464 include isolating the layer that the object resides to view in the drawing, highlighting all linked objects, un-highlight all objects and show all un-linked objects. The link editor tool enables the user to visually see what intelligent objects were defined using the application of the present invention and to modify, edit, view, or zoom in to see those objects defined or not defined.

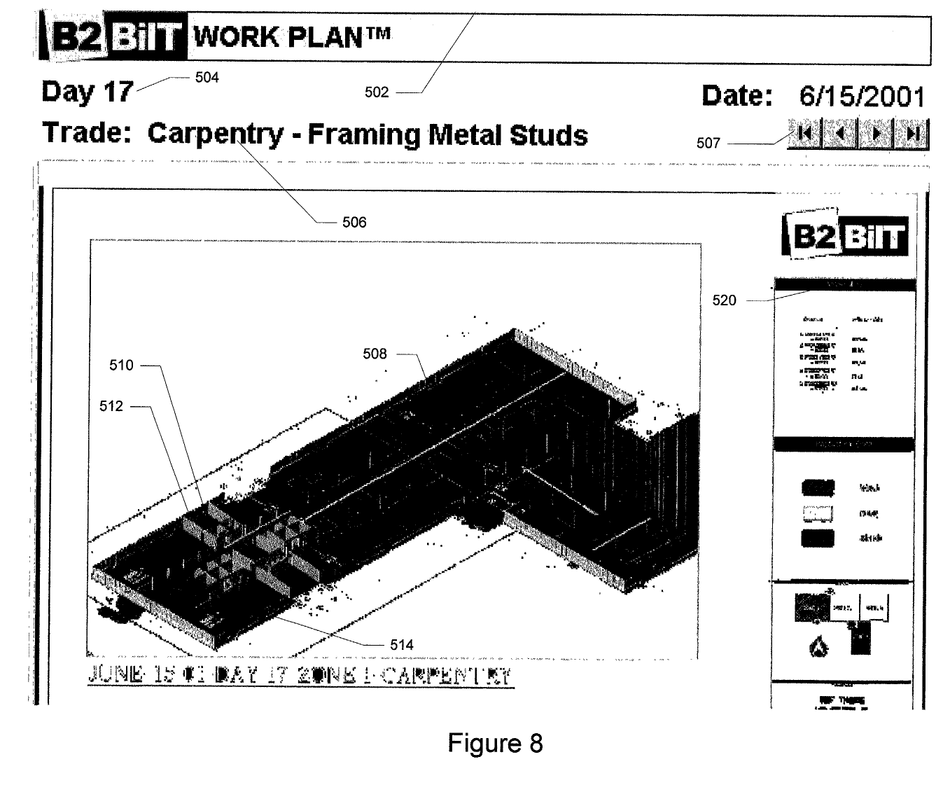

FIG. 8 is a screen-capture of a resulting work plan output of the present invention in the preferred embodiment. The construction planning system work plan output 502 comprises of a modified electronic design drawing of a building that is color-coded based on project status for a particular day and specific trade. For example, the user specified date 504 is shown for a particular date in the project schedule; specifically, FIG. 8 shows that the user selected “Day 17”, which happens to be Jun. 15, 2001 and is viewing the project status for the trade 506 “carpentry—framing metal studs.” At 507, the user may utilize the day scrolling function to advance forward, backward, first date of project or last date of project by selecting the scroll function.

The electronic drawing 508 is stored as an object in the construction planning system knowledge base database and used in a modified form with specific date, phase, and color-coded information in the work plan output. Project status for this particular phase shows that the construction project through the construction planning application adds the color green 510 to those assemblies and elements to indicate work ahead of schedule, yellow 512 to indicate currently scheduled work, and red 514 to indicate work behind schedule. Construction planning system work plan menu 520 provides work plan information such as a project code key to color-coding illustrated on the electronic drawing representation, a perspective of the view the user is seeing and assembly/element information relevant to the current view.

What is claimed:

1. A method of obtaining and displaying to a user, information that is relevant to a construction project, said method comprising the steps of:
storing in a database, design data, said design data including at least one material list quantity associated with the electronic design;
automatically exporting at least one design element;
retrieving the design data which was exported;
associating retrieved design data with user input data; and
displaying to the user, the design data associated to the user input data.

2. The method of claim 1 wherein the design data is initially stored in a design database, and the step of storing the design data in the user database includes importing the design data from an electronic drawing software application tool.

3. The method of claim 1 wherein the design data includes construction project material information, and the method further comprises exporting that information into a graphical user interface.

4. The method of claim 1 wherein the user is a project manager, planner or estimator; the design data is construction building information; and the input data is material quantities, and the step of electronically viewing the design and input data includes the steps of:
storing the design and input data into a memory; and
interfacing the memory with a database application that electronically stores the data for use by the user.

5. The method of claim 1 wherein the step of retrieving data includes automatically importing data from a precision estimating application.

6. A system for obtaining and displaying to a user, information that is relevant to a construction project, said system comprising:
a user database for storing design data from computer aided design software, said design data including at least one design material; an interface that automatically imports computer aided design information and retrieves design information in which the design data is utilized;
means for associating the retrieved design data with quantities and descriptions; and
a user display that displays the design data, a list of the materials, a quantity associated with each material and a description associated with each material.

7. The system of claim 6 wherein the design data from a computer aided design application is initially exported into a design database, and the system further comprises means for importing the design data from the design database into the user database.

8. The system of claim 6 wherein the user is a project manager and the design data is construction information and is relevant to the user.

9. The system of claim 6 further comprising:
a memory for storing the exported design data;
means for creating a document by the user, said document creating means including means for importing information from a database and utilizing the data in the document; and
a report generation application interfaced with the document creating means that electronically creates work plan documents initiated by the user for a time period selected by the user.

10. A system for processing and outputting construction execution documents in the construction industry comprising:
a central processing unit; knowledge base database; computer aided design interface means for exporting element and assembly information to ascii file; estimating software interface for maintaining the material list information to knowledge base database; application means of updating material, assembly and element data; cost update means to recalculate costs; report generation means to output construction work plan; project means to output project plan for a user specified period; report means to generate construction execution documents and computer aided design means to import updated element and assembly data.

11. The system of claim 10, wherein computer aided design means redraws assemblies and elements in green to show project status as on-time.

12. The system of claim 10, wherein the computer aided design means redraws assemblies and elements in the color yellow to show project status as in process.

13. The system of claim 10, wherein the computer aided design means redraws assemblies and elements in the color red to show project status as behind schedule.
